(19) United States
(12) Patent Application Publication
(10) Pub. No.: US 2026/0074093 A1
(43) Pub. Date: Mar. 12, 2026

(54) IMPROVED METHOD FOR MANUFACTURING A MEDIUM- OR HIGH-VOLTAGE ELECTRIC CABLE

(71) Applicant: NEXANS, Courbevoie (FR)

(72) Inventors: François Sessouc, Calais (FR); Quentin Eyssautier, Hafslundsøy (NO); Jean-François Brame, Coulogne (FR); Erik Markus Jarvid, Kungälv (SE); Christelle Mazel, RUY (FR)

(21) Appl. No.: 19/076,163

(22) Filed: Mar. 11, 2025

(30) Foreign Application Priority Data
Mar. 11, 2024 (FR) 2402422

(51) Int. Cl. H01B 13/08; H01B 13/00

(52) U.S. Cl. CPC H01B 13/0891; H01B 13/0016

(57) ABSTRACT

The invention relates to a method for manufacturing a medium- or high-voltage electric cable, of the type comprising:
a core formed of an elongate electrically conductive element and of an insulating system comprising at least one layer comprising at least one cross-linked polyethylene, said at least one layer being arranged coaxially around the elongate electrically conductive element, and
a tape enveloping the core
the tape being formed of a semiconductor polymer material.,
characterised in that the method comprises at least one step of extracting at least one chemical species from the tape, said chemical species being a chemical species able to reach the insulating system by migration from the tape and to decrease the dielectric performance of the insulating system.

### CROSS REFERENCE TO RELATED APPLICATION

This application is related to and claims the benefit of French Patent Application No. 2402422 filed on Mar. 11, 2024, the entire contents of which are herein incorporated by reference.

### TECHNICAL FIELD

The invention relates to the technical field of manufacturing power cables.

The invention relates to a method for manufacturing a medium- or high-voltage electric cable, and also to an electric cable which can be obtained by this method. The invention therefore relates to and applies to the manufacture of medium-voltage (in particular, from 6 to 45-60 kV) or high-voltage (in particular, greater than 60 kV, and being able to go up to 800 kV) power cables, whether they are direct current (HVDC) or alternating current (HVAC).

The invention relates to and applies in particular to the manufacture of medium-voltage or high-voltage electric cables of the type comprising an insulating system comprising at least one layer comprising at least one cross-linked polyolefin, in particular comprising at least one layer comprising at least one cross-linked polyethylene (cables of the “HVDC XLPE” type for “High Voltage Direct Current Cross-linked Polyethylene” or of the “HVAC XLPE” type for “High Voltage Alternating Current Cross-linked Polyethylene”).

The invention thus has applications in the fields of air, underwater, land electricity transmission or also of aeronautics.

The invention relates to and applies to the manufacture of medium- and high-voltage electric cables and connectors of such cables for land applications, but also extends to the manufacture of connectors of underwater medium- and high-voltage electric cables.

The invention relates to and applies more specifically to the manufacture of a medium- or high-voltage electric cable, of the type comprising:
a central core formed of at least one elongate electrically conductive element, in particular made of copper or aluminium, and of at least one insulating system, each insulating system being arranged coaxially around an elongate electrically conductive element, at least one layer of the insulating system comprising cross-linked polyethylene (XLPE), and
a tape surrounding and enveloping the central core, in contact or not with said central core, and contributing to the formation of a sheath surrounding the core of the electric cable.

The invention relates to and applies to the manufacture of a medium- or high-voltage electric cable, wherein the insulating system comprises at least one (semiconductor or electrically insulating) layer comprising at least one cross-linked polyethylene.

Throughout the text, the expression “cross-linked polyethylene” extends to any cross-linked polyethylene (XLPE) by any cross-linking method, known to a person skilled in the art, such as, for example, peroxide (and/or organic peroxide) cross-linking, electron beam cross-linking, silane cross-linking, ultraviolet radiation cross-linking, and others.

Throughout the text, the following terms are used:
“electrically insulating layer”, a layer the electrical conductivity of which can be very low, even zero, and in particular, of at most 10⁻⁶ S/m (Siemens per metre), or of at most 1.10⁻⁸ S/m (Siemens per metre), or of at most 1.10⁻⁹ S/m, or of at most 1.10⁻¹⁰ S/m or of at most 10⁻¹³ S/m (measured at 25° C. in direct current), and
“semiconductor layer”, a layer the electrical conductivity of whichcan be strictly greater than 1.10⁻⁸ S/m (Siemens per metre), preferably of at least 1.10⁻³ S/m, and preferably can be less than 1.10³ S/m (measured at 25° C. in direct current).

The semiconductor layer has an electrical conductivity greater than that of the electrically insulating layer. More specifically, the electrical conductivity of the electrically insulating layer can be at least 10 times less than the electrical conductivity of the semiconductor layer, preferably at least 100 times less than the electrical conductivity of the semiconductor layer, and in particular preferably, at least 1000 times less than the electrical conductivity of the semiconductor layer.

The electrical conductivity level of the insulating system of such electric cables impacts the dielectric strength of the insulating system and, consequently, the dielectric performance of the electric cable. In other words, the lower the electrical conductivity of the insulating system, the greater the performance of the electric cable and of the insulating system. Electrical conductivity is an intrinsic property of the material. As regards electric cables comprising an insulating system comprising cross-linked polyethylene, the electrical conductivity of this insulating system is able to increase, due to an intake of exogenous chemical species into the insulating system.

Such an increase of the electrical conductivity of the insulating system constitutes a considerable threat to the reliability of the energy transmission network with economic consequences generated by the failure of the electrical energy distribution network.

The invention aims to overcome this disadvantage.

### BACKGROUND

A method for immobilising cross-linking by-products of a cross-linked polyethylene (XLPE)-based insulating system of an electric cable intended for the transmission of medium-voltage or high-voltage energy is known from EP3699931. The electric cable of EP3699931 is made by extruding the insulating system onto the electrical conductor, the insulating system also comprising a carrier layer of a zeolitic system comprising a first CBV 600 zeolite intended to absorb the cross-linking by-products of the insulating system and an A3 zeolite intended to absorb the water formed due to oligomerisation and decomposition reactions of said cross-linking by-products of the insulating system during or after their absorption by the first zeolite, the oligomerisation and decomposition reactions being accompanied by an in situ water formation.

The electric cable of EP3699931 requires to incorporate two types of zeolite particles, one type of particles of which intended for the absorption of cross-linking by-products and one type of particles of which intended for the irreversible absorption of water molecules due to said absorption of the by-products.

The manufacture of the electric cable of EP3699931 is complex and the zeolitic system is able to affect the electrical and/or mechanical properties of the electric cable.

The invention aims, in particular, to provide a method for manufacturing a medium- or high-voltage electric cable, making it possible to limit the loss of dielectric performance of the insulating system, even to maintain or preserve the dielectric performance of the insulating system of an electric cable of the HVDC-XLPE type or of the HVAC-XLPE type.

The invention also aims to propose such a method for manufacturing a medium- or high-voltage electric cable making it possible to maintain the dielectric performance of the insulating system and, preferably, while preserving good mechanical properties of the electric cable.

### SUMMARY OF THE INVENTION

To that end, the invention relates to a method for manufacturing a medium- or high-voltage electric cable, of the type comprising:
a core formed of an elongate electrically conductive element and of an insulating system comprising at least one and in particular a plurality of layers comprising at least one cross-linked polyethylene, said at least one layer being arranged coaxially around the elongate electrically conductive element, and
a tape enveloping the core and extending in contact or not (or away from) with the core,
characterised in that the method comprises at least one step of extracting at least one chemical species, in particular at least one undesirable chemical species, from the tape, said chemical species being a chemical species able to reach the insulating system by migration from the tape during use of the cable and to decrease the dielectric performance of the insulating system, and in that the tape is subjected to said at least one step of extracting prior to the application of the tape around the core of the electric cable.

The inventors have observed that semiconductor tapes of the prior art, applied around and enveloping the one or more layers of the insulating system comprising cross-linked polyethylene, in particular but not exclusively semiconductor layers comprising polyethylene XLPE, are, in reality, of the nature of being able to contribute to a modification over time, of the electrical conductivity properties of the insulating system of electric cables during use, in particular medium- and high-voltage direct current (HVDC) electric cables. Without being supported by a scientific approach, the inventors assume that the semiconductor tapes of the prior art incorporate chemical species which are able to migrate into the insulating system comprising at least one cross-linked polyethylene for the lifespan of the electric cable and to modify its properties, and have been found to be undesirable. These chemical species are qualified, throughout the present text, as undesirable chemical species. The inventors have further determined that a step able to lead to an extraction of all or some of these undesirable chemical species, in reality makes it possible to limit the loss of dielectric performance of the insulating system, even to maintain this dielectric performance of the HVDC cable insulating system. Yet, maintaining the electrical conductivity of the cross-linked polyethylene insulating material as low as possible is an essential aim to be achieved when manufacturing medium- or high-voltage electric cables comprising at least one cross-linked polyethylene (XLPE).

But, the inventors have also observed that these undesirable chemical species, in particular water, constitute a problem for alternating current electric cables (HVAC), as they can lead to a degradation of the dielectric performance of the tree structure insulating system. The method according to the invention makes it possible to extend the lifespan of alternating current cables, in particular of a cable of a humid design (without a metallic barrier against water), for which the time necessary to reach humidity conditions able to initiate the degradation of the dielectric performance can be considerably extended.

The insulating system of the electric cable can be formed by at least one layer arranged coaxially around the central elongate electrically conductive element. In some of these known embodiments, the insulating system is formed of a plurality of layers arranged coaxially around the elongate electrically conductive element, including at least one semiconductor layer and at least one electrically insulating layer.

In some of these embodiments, the insulating system is formed of a plurality of layers arranged coaxially around the central elongate electrically conductive element, including a first semiconductor layer called the “internal semiconductor layer” extending in contact with the elongate electrically conductive element, an electrically insulating layer extending in contact with said internal semiconductor layer and a second semiconductor layer called the “external semiconductor layer” extending in contact with the electrically insulating layer.

These three layers are typically layers comprising at least one polymer—in particular, at least one cross-linked polyethylene—and obtained by techniques well known to a person skilled in the art, by cross-linking a precursor composition comprising at least one polymer, in particular at least one non-cross-linked polyethylene. The cross-linked polymers of the different layers can be distinct or identical. The cross-linked polyethylenes of the different layers can be distinct or identical.

According to the invention, the tape is adapted to prevent a migration and a progression of water in the longitudinal direction of the electric cable in the case of damage to the electric cable in service. The tape is adapted to form a barrier preventing a direct contact between the layers between which it is interposed, in particular between the external stranded layers and the insulating system of the electric cable.

According to the invention, the tape is a long strip and of substantially constant width and very much less than its length. According to the invention, the tape is formed of at least one solid material able to contain at least one undesirable chemical species and able to reach the insulating system by migration from the tape during the use of the electric cable comprising the tape.

According to the invention, the tape is formed of at least one flexible material selected according to the expected functionalities of the tape. By “tape formed of at least one flexible material” or “flexible tape”, this means a tape the material and the dimensions, in particular the thickness, of which are adapted to be able to enable a winding of the tape about an axis orthogonal to the largest dimension (length) of the tape in view of storing the tape and to be able to enable an unwinding of the tape during its implementation around—in contact or not—the core of the electric cable moved along a longitudinal axis of the electric cable being manufactured.

According to some embodiments, the tape is a protective tape. This can be a protective tape against attacks of a chemical and/or physical nature. According to some embodiments, the tape is a tape which protect the core of the electric cable. According to some embodiments of a method according to the invention, the tape is applied by helical winding on the external face of the insulating system of the cable by having overlapping zones, or not. According to some other embodiments, individually or combined, the tape can be applied on the surface of a more external layer of the electric cable by helical winding around said more external layer of the electric cable by having overlapping zones, or not. Any other application method is possible. There is nothing to prevent, according to some embodiments, applying the tape by folding/winding the tape about its longitudinal axis around the core of the electric cable or around a more external layer of the electric cable surrounding the core of the electric cable. According to these embodiments, the two longitudinal edges of each tape section are folded facing one another.

According to some embodiments, the tape is formed of at least one material selected from the group formed of polymer materials. According to some embodiments, the tape is formed of at least one material selected from the group formed of woven materials and of non-woven materials. According to some embodiments, the tape is formed of at least one woven material. According to some embodiments, the tape formed of at least one woven material has better tensile strength than a tape formed of at least one non-woven material. According to some embodiments, the tape formed of at least one material, in particular a woven material, has a tensile strength value of between 10N/cm and 200N/cm. According to some embodiments, the tape is formed of a non-woven and swelling material.

By “swelling material”, this means a material able to swell upon contact with water, for example, by absorption of water. Advantageously, a tape made of at least one swelling material is adapted to act as a water blocking material by opposing the axial propagation of water blocked between the layers—in particular polymer (plastic) and metallic layers—framing the tape on its two main faces.

According to some embodiments, the tape can be formed of at least one swelling material. According to these embodiments, the tape made of swelling material can make it possible to preserve the core of the electric cable against the water, for example, by water collection/absorption. But, the swelling material can also enable reciprocal physical protection between two layers made of distinct materials, in particular between a layer made of at least one polymer material and a layer made of a metallic material.

According to some embodiments, the tape can be formed of at least one non-swelling material. Such a tape made of at least one non-swelling material can enable a reciprocal physical protection between two layers made of distinct materials, in particular between a layer made of at least one polymer material and a layer made of a metallic material.

According to some embodiments, the tape is formed of a polymer material. According to some embodiments, the tape is formed of at least one semiconductor polymer material. The tape formed of at least one semiconductor polymer material favours electrical contact between the layers framing the tape, in particular a semiconductor polymer layer and a metallic layer.

According to some embodiments, the tape is formed of a plurality of layers sandwiched on top of one other and each having at least one of the properties mentioned. According to these embodiments, the layers of the plurality of layers can be formed of similar or distinct materials.

According to some embodiments, the tape is formed of at least one material selected from the group of textile fibres. According to some embodiments, the tape is formed of at least one material selected from the group of polymer materials comprising, for example, nylons, polyesters, rayon, etc. According to some embodiments, the material forming the tape can comprise at least one additive such as a corrosion inhibitor and/or an absorbent powder. The material(s) forming the tape are selected to obtain the properties required for the tape, such as the mechanical properties, the swelling properties. The material(s) forming the tape are selected to obtain the required dimensions.

According to some embodiments, the tape can have a width of a value of between 20 mm and 200 mm. The tape can have a thickness of a value of between 0.1 mm and 1 mm. The tape can have a density of a value of between 10 g/m² and 300 g/m².

The tape can be disposed directly in contact with a face forming the outer face of the insulating system of the cable. But, the tape can be disposed without direct contact with the face forming the outer face of the insulating system of the cable, operational or non-operational layers being able to be interposed between the core of the cable and the tape.

According to these embodiments, with the tape being packaged in the form of a roll or a wafer, said roll of tape is placed in an extraction chamber for a sufficient duration to enable said extraction. According to these embodiments, with the tape being packaged in the form of a roll or wafer, said roll of tape is placed in said extraction chamber for a sufficient duration and under conditions (in particular of temperature and/or pressure and/or ventilation) adapted to enable said extraction.

According to these embodiments, a roll of tape is subjected to pre-packaging in an extraction chamber for a sufficient duration to enable said extraction, prior to it being placed around the core of the electric cable at the finishing stage. The pre-packaging of the tape in the extraction chamber and the extraction of undesirable chemical species can be obtained remotely from the manufacture and production site of the electric cable and independently from the manufacture of the electric cable. The tape substantially free of undesirable chemical species can be preserved and/or stored before it is put into place around the core of the electric cable.

According to other embodiments, individually or combined with a preceding embodiment, nothing prevents providing placing the electric cable provided with the tape and packaged in a roll or wafer in an extraction chamber for a sufficient duration to enable said extraction. According to some of these other embodiments, the electric cable can be a section of land electric cable having a length of between around 1000m and around 2000m.

However, nothing prevent to provide, according to other embodiments, individually or combined with at least one preceding embodiment, that the tape is subjected to said extraction step during (together with) the application of the tape around the core of the electric cable, i.e. in contact with the core of the electric cable or in contact with a more external layer of the electric cable. According to these other embodiments, the electric cable can be an underwater electric cable section having a length of around 10000m or more.

According to some of these other embodiments, it is possible to form the core of the electric cable by extrusion/cross-linking of the insulating system at the surface of the central elongate electrically conductive element according to a technique known per se, then to apply the tape on the surface of the core of the electric cable and to proceed to the step of extracting at least one undesirable chemical species from the constituent material of the tape, said tape extending at the surface of the core of the electric cable.

According to some embodiments, said extraction step is a step of heating the tape, to a temperature selected to enable said extraction.

According to these embodiments, said extraction step is a step of heating the tape, carried out by means of a radiative heating member—in particular a Joule effect heating member or a heat pipe—or of an inductive heating member. According to these embodiments, said extraction step is a step of heating the tape, to a temperature selected according to the nature of these chemical species, to enable said extraction. Naturally, according to the invention, the temperature and the duration of heating the tape are controlled, so as not to degrade the physical properties of the tape. According to these embodiments, said step of heating the tape is carried out in an extraction chamber comprising means for heating an inside space of said extraction chamber, and the extraction of undesirable chemical species from the tape can be obtained remotely from the manufacture and production site of the electric cable and independently from the manufacture of the cable.

According to some of these other embodiments, individually or combined with one of the preceding embodiments, said extraction step comprises at least one step of blowing a flow of a gaseous composition in contact with the tape, said tape extending at the external surface—in particular at the external surface of the core—of the electric cable being manufactured. According to some of these embodiments, the flow of gaseous composition is at ambient temperature. According to some of these embodiments, the flow of gaseous composition is a flow of atmospheric air. According to some of these embodiments, the flow of gaseous composition can be a flow of atmospheric air at ambient temperature or at a temperature greater than ambient temperature.

According to some embodiments, the blowing of a flow of gaseous composition in contact with the tape is carried out in a tubular space which is open at its two longitudinal ends, and in which the electric cable being manufactured—in particular the core of the electric cable being manufactured—and said tape extending at the surface of the electric cable being manufactured are moved together.

Any other extraction means is possible, individually or combined.

According to some embodiments, said undesirable chemical species can be water. This can be water formed during the manufacture of the tape and being able to subsequently reach at least one layer of the insulating system by migration from the tape during use of the electric cable, and to decrease the dielectric performance of this layer and of the insulating system. For example, this can be water formed due to oligomerisation and decomposition reactions of cross-linking by-products of the tape made of cross-linked polymer material.

In these embodiments, with at least one undesirable chemical species of the tape being water, the heating temperature of the tape is selected to enable an extraction of at least some of this water.

In other embodiments, said undesirable chemical species can be a manufacturing by-product of at least one material forming the tape.

According to some embodiments, the heating temperature of the tape is between ambient temperature and a temperature preserving the physical properties of the tape. According to some embodiments, the heating temperature of the tape is between 50° C. and 100° C. The heating temperature of the tape applied on the electric cable (on the core of the electric cable or on a more external layer of the electric cable) is selected to not modify the performance of the electric cable and, in particular, the performance of the core of the electric cable. According to some embodiments, it is possible to choose a heating temperature of the tap which is high and an exposure duration of the tape which is short. According to some other embodiments, it is possible to choose a heating temperature of the tape which is lower and an exposure duration of the tape which is increased.

According to some embodiments, the electric cable is a medium- or high-voltage electric cable in which at least one layer, in particular each layer, of the insulating system comprises at least one cross-linked polyethylene.

According to some embodiments, with the electric cable being an underwater cable comprising connectors, tape portions extending facing the connectors are subjected to said at least one extraction step.

According to some embodiments, the electric cable is a medium- or high-voltage direct current (HVDC) electric cable.

According to some embodiments, the electric cable is a medium- or high-voltage alternating current (HVAC) electric cable. The presence of undesirable chemical species—in particular, water—in the tape is a problem for alternating current cables. In particular, the presence of water can lead to tree structure degradation. The method according to the invention therefore makes it possible to maintain the lifespan of such alternating current electric cables, and in particular of factory connectors. The method according to the invention therefore makes it possible to manufacture such electric cables and to maintain the lifespan of such alternating current electric cables for a use in a humid environment, in particular alternating current electric cables which do not have a protective metallic barrier against water. The method according to the invention therefore makes it possible to manufacture such alternating current electric cables for which the time necessary to reach humid conditions marking the start of degradation, by diffusing water through the tape, can be considerably extended.

In a method according to the invention, said extraction step is limited to an extraction of undesirable chemical species, in particular water, from the tape.

The invention also extends to a medium- or high-voltage electric cable able to be obtained—in particular obtained—by a method according to the invention. A medium- or high-voltage electric cable according to the invention comprises an insulating system, the dielectric properties of which are at least substantially maintained over time.

### BRIEF DESCRIPTION OF THE DRAWINGS

Other features and advantages of the invention will also appear upon reading the description below. This is purely illustrative, and must be read with reference to the accompanying drawings, in which:

FIG. 1 is a schematic representation of a cross-section of an electric cable according to a particular embodiment of the invention, and;

FIG. 2 is a graphical representation of comparative results provided by the method according to the invention on the breakdown strength of a medium-voltage electric cable.

### DETAILED DESCRIPTION

The power cables or electric cables typically comprise an elongate central electrical conductor element and an insulating system extending in contact with the outer face of the elongate central electrical conductor element and comprising at least one electrically insulating layer cross-linked by techniques well known to a person skilled in the art, for example, by peroxide or other means. The cross-linked electrically insulating layer can be a cross-linked polyethylene (XLPE) layer. But, the insulating system can also comprise a plurality of layers, superposed and coaxial with the elongate central electrical conductive element, including a first semiconductor layer called an “internal semiconductor layer” extending in contact with an external surface of the elongate central conductor element, an electrically insulating layer extending in contact with an external surface of said internal semiconductor layer, and a second semiconductor layer called an “external semiconductor layer”extending in contact with an external surface of the electrically insulating layer. Each of the layers of the insulating system can comprise a polymer material such as a cross-linked polyethylene, in particular the same cross-linked polyethylene. Each of said internal semiconductor layer and external semiconductor layer comprises a semiconductor filler in a sufficient amount to make the corresponding layer semiconductive.

For reasons of clarity, only the elements essential for understanding the embodiments described below have been represented schematically, and this, without necessarily respecting the relative dimensions of the constituent elements of the electric cable.

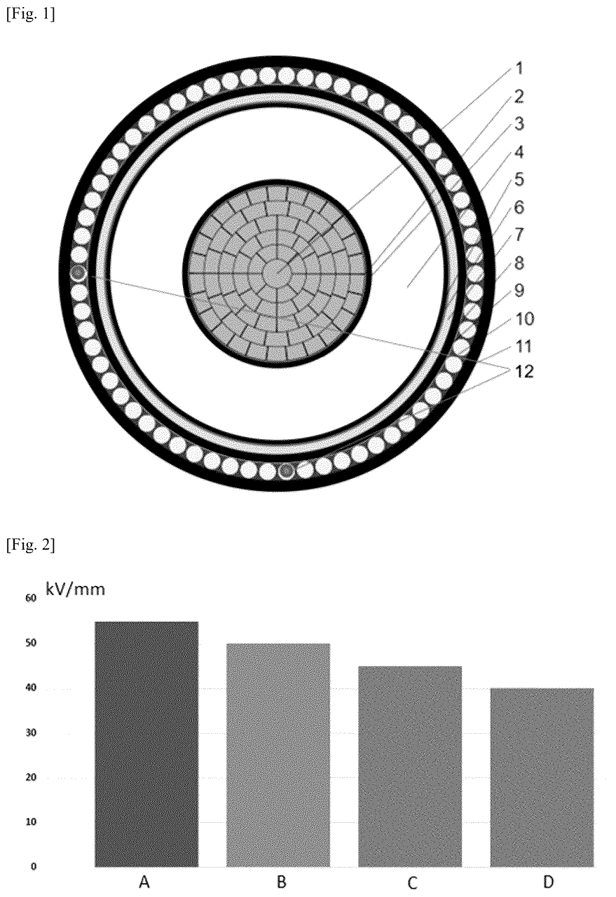

A cross-section of a medium- or high-voltage electric cable 1 shown in FIG. 1 as an illustrative, but non-limiting example of the invention, comprises an elongate central conductor core 1. The elongate conductor core 1 can be of any type. It can be in particular, but not exclusively, of the type comprising at least one elongate electrically conductive element, for example in the form of at least one electrically conductive metallic wire, in particular made of copper or of aluminium, and at least one insulating system, each insulating system being disposed coaxially around an elongate electrically conductive element.

The insulating system of the elongate central conductor core 1 can comprise a plurality of layers, including at least one layer made of at least one cross-linked polymer material, arranged coaxially and successively around this elongate electrically conductive element, enveloping the elongate electrically conductive element, including, for example:
a first semiconductor layer called the “internal semiconductor layer” extending in contact with an external surface of the elongate electrically conductive element,
an electrically insulating layer extending in contact with an external surface of said internal semiconductor layer,
a second semiconductor layer called the “external semiconductor layer” extending in contact with an external surface of the electrically insulating layer. Other insulating systems are possible.

The electric cable of FIG. 1 has a tape 2 extending in contact and surrounding the elongate central conductor core 1. The tape 2 is a tape obtained by a method according to the invention, and surrounding the elongate central conductor core 1. The tape 2 can be helically wound around the elongate central conductor core 1, by having overlapping zones, or not, or be folded radially over the core of the electric cable.

The electric cable shown in FIG. 1 also comprises, successively:
a shroud 3 of the conductor extending in contact with the external face of the tape 2 and surrounding the elongate central conductor core 1 and the tape 2,
an insulating layer 4 arranged in contact with the external face of the shroud 3 and covering said shroud 3,
a shroud 5 of the insulating layer 4 disposed in contact with the external face of the insulating layer 4 and surrounding the underlying elements 1, 2, 3, 4,
a longitudinal water blocking element 6 disposed in contact with the shroud 5. The longitudinal water blocking element 6 is a tape 6 obtained by a method according to the invention, and surrounding the underlying elements 1, 2, 3, 4, 5,
an external assembly comprising a plurality of successive layers, in particular a protective layer 7 made of lead forming a metallic barrier arranged in contact with the external face of the longitudinal water blocking element 6, an internal sheath 8 of the external assembly, a padding 9 accommodating armouring wires 10 and a layer 11 forming an interface of the electric cable with its environment. In the embodiment shown, some armouring wires 10 are replaced by elements 12 of optical fibres contained in metallic tubes (FIMD, “Fibre In Metallic Tube”).

The tape 2 makes it possible to oppose and prevent water migration along the longitudinal axis of the cable in case of damage to the latter during its operation. But, the tape 2 also makes it possible to prevent direct contact of the materials (“stranding materials”) of the peripheral layers with the insulating system.

The tape 6 surrounding the underlying elements 1, 2, 3, 4, 5 extends under the protective layer 7 made of lead forming a metallic barrier against water. The tape 6 makes it possible to make contact between the metallic barrier 7 and the underlying cross-linked polyethylene. The tape 6 also makes it possible to oppose a propagation of water in case of infiltration in the electric cable.

According to some embodiments, the invention aims for a method for manufacturing a medium- or high-voltage electric cable, comprising:
a cross-linked polyethylene-based core (HVDC XLPE or HVAC XLPE type cables), of the type comprising a central elongate electrically conductive element, in particular made of copper or aluminium, and an insulating system comprising or formed of a plurality of layers arranged coaxially around this central elongate electrically conductive element, including a first semiconductor layer called the “internal semiconductor layer” extending in contact with the elongate electrically conductive element, an electrically insulating layer extending in contact with said internal semiconductor layer and a second semiconductor layer called the “external semiconductor layer” extending in contact with the electrically insulating layer, and
a tape enveloping the core and formed of a flexible semiconductor material. The three layers forming the insulating system are typically layers of polymer(s)—in particular polyethylene—cross-linked by techniques known to a person skilled in the art.

At least one of the insulating and/or semiconductor layers—in particular each of the insulating and semiconductor layers—comprises at least one cross-linked polyethylene.

### The Core of the Electric Cable

The core of the electric cable can be obtained by any method known to a person skilled in the art, for example by extrusion/cross-linking (in particular by co-extrusion/cross-linking) of the insulating system around a central elongate electrically conductive element, according to any technique known per se.

The precursor compositions of the insulating and semiconductor layers of the insulating system can be co-extruded around the elongate electrically conductive element and the cross-linking of the co-extruded precursor compositions around the elongate electrically conductive element is induced by activation of the corresponding cross-linking agent.

For example, the cross-linked semiconductor and insulating layers of the insulating system are obtained from precursor compositions based of a polyethylene polymer matrix associated with organic peroxides. The cross-linking of these precursor compositions is typically induced by a heat treatment during the extrusion of the one or more insulating and semiconductor layers around the elongate electrically conductive element.

The cross-linked polymer materials of the different layers of the insulating system can be obtained from one same polyethylene precursor matrix. However, there is nothing to prevent at least two of the layers of the insulating system from being obtained from distinct polyethylene precursor matrices.

### Tape

At least one constituent material of the tape can be a polymer material, in particular a semiconductor polymer material. At least one constituent material of the tape can be a non-woven material, in particular a swelling non-woven material. The tape can be formed of at least one material selected from the group of polymer materials. The tape can be formed of at least one material selected from the group of textile fibres. The tape can be textile fibres comprising nylons, polyesters, rayon, in particular.

### Extraction Step

The method according to the invention for manufacturing an electric cable provides at least one step of extracting at least one chemical species from the tape, said chemical species being a chemical species able to reach the insulating system by migration from the tape and to decrease the dielectric performance of the insulating system.

According to a first embodiment, a roll of tape is subjected to a heating step in a furnace. The dimensions of the furnace are selected to enable the heating of the necessary number of rolls. An air circulation between the outside and the inside of the furnace is established, so as to drive the undesirable chemical species—in particular humidity—extracted from the tapes. The temperature in the furnace is between 50° C. and 100° C.

According to a second embodiment, the tape wound on the central core of the electric cable is subjected to a heating step by blowing hot air at a temperature of between 50° C. and 100° C. onto the tape. In this second embodiment, the hot air blown is a dry air. Preferably, the hot air is dried by means of a dehumidifying agent, such as, for example, silica, before being blown onto the tape. This second embodiment has the advantage of being able to be implemented on a cable production line as a continuous system.

According to another embodiment, nothing prevents the electric cable, i.e. the electric cable provided with the tape, from being subjected to the heating step in a ventilated furnace heated to a temperature of between 50° C. and 100° C.

In a particular embodiment, a step of extracting at least one undesirable chemical species from the tape is carried out by subjecting the tape to said extraction step prior to placing the tape to envelope the core of the electric cable.

According to this embodiment, the tape substantially free of undesirable chemical species, can be preserved until its application on the core of the cable.

It is possible to carry out said extraction step by placing the protective cable in a heating chamber and by heating said material to a temperature selected to enable an extraction of at least one undesirable chemical species from the tape. For example, the tape can be packaged in a form wound on a coil, adapted to enable a subsequent application on the surface of the electric cable being manufactured—in particular on the surface of the core of the electric cable being manufactured—of a tape at least partially free of undesirable chemical species, such as obtained after being subjected to said extraction step. In this particular embodiment, said extracting step is a step of heating the tape and of vaporising at least partially at least one of the undesirable chemical species. In this particular embodiment, said extraction step is carried out, so as to extract at least one of the vaporised undesirable chemical species from the extraction chamber.

In this embodiment, nothing prevents the formation of a flow of gaseous composition passing through said extraction chamber, so as to drive at least one of the vaporised undesirable chemical species away from the tape.

According to some of these embodiments, the tape obtained by the method according to the invention can be applied on the surface of factory seals for electric cables intended for an underwater use, for which the risk of migration of undesirable chemical species is the same as for an electric cable.

In another embodiment of a method according to the invention, a step of extracting at least one undesirable chemical species from the tape is carried out by subjecting the tape to said extraction step during the placing of the tape to envelope the core of the electric cable, or subsequently to said placing of the tape around the core of the electric cable. In these embodiments, the core of the cable is moved along its longitudinal axis and the tape is applied and secured to the core of the moving cable. In these embodiments, the electric cable formed by application and enveloping of the tape around the core of the electric cable is subjected to said extraction step by blowing a flow of gaseous composition—in particular a flow of atmospheric air—directed and applied on the external face of the tape. In some embodiments, said blowing extraction step is carried out in an extraction chamber formed of a tube passed through by the moved electric cable, the flow of gaseous composition being directed and applied to the external face of the tape of the protective cable moved in the tube. According to some embodiments, the flow of gaseous composition and/or the internal space of the tube is (are) heated to a temperature adapted to enable a vaporisation of at least one undesirable chemical species of the tape applied on the core of the electric cable.

Due to this extraction of undesirable chemical species from the tape of the electric cable, the loss of dielectric performance of said electric cable obtained by a method according to the invention is limited, in particular the dielectric performance of said electric cable is maintained during the use of the electric cable.

### EXAMPLE

FIG. 2 is an illustration of the results obtained by a method according to the invention. Non-woven, water-swellable tapes have been pre-packaged and then wound around a medium-voltage cable. Pre-packagings include:
A—tape dried for 24 hours at a temperature of 100° C. in a furnace,
B—tape placed for 24 hours in a chamber with a humidity rate of 30% at 25° C.,
C—tape placed for 24 hours in a chamber with a humidity rate of 50% at 25° C., and
C—tape placed for 24 hours in a chamber with a humidity rate of 80% at 25° C.

The tapes thus obtained are each wound around the cross-linked polyethylene external semiconductor layer (XLPE) of a medium-voltage electric cable comprising an elongate electrically conductive element and an insulating system arranged coaxially around the elongate electrically conductive element. The insulating system comprises an internal semiconductor layer extending in contact with an external surface of the elongate electrically conductive element, an electrically insulating layer extending in contact with an external surface of said internal semiconductor layer, and an external semiconductor layer extending in contact with an external surface of the electrically insulating layer. Each cable equipped with one of the tapes A, B, C or D is subjected to successive high-voltage cycles, each cycle having a duration of 12 hours, the high voltage increasing between two successive cycles and by application to the cable of a temperature at most equal to +90° C. for 4 hours and cooling the cable to ambient temperature. The increase of the high voltage during the cycles continues until reaching the breakdown voltage. The breakdown strength given in FIG. 2 corresponds to the high voltage value having led to the breakdown.

The results presented in FIG. 2 have been obtained by heating the tapes to the temperature of 100° C., but tests carried out at a lower temperature (70° C.) have led to very similar results.

Due to said step of extracting undesirable chemical species from the tape, the breakdown strength of said electric cable obtained by the method according to the invention is increased and the loss of dielectric performance of said electric cable obtained by a method according to the invention can be limited.

1. Method for manufacturing a medium- or high-voltage electric cable, of the type comprising:
a core formed of an elongate electrically conductive element and of an insulating system comprising at least one layer comprising at least one cross-linked polyethylene, said at least one layer being arranged coaxially around the elongate electrically conductive element, and
a tape enveloping the core and extending in contact or not with the core, characterised in that the method comprises at least one step of extracting at least one chemical species from the tape, said chemical species being a chemical species able to reach the insulating system by migration from the tape and to decrease the dielectric performance of the insulating system.

2. Method according to claim 1, characterised in that the tape is formed of at least one material selected from the group formed of non-woven materials and of polymer materials.

3. Method according to any one of claims 1 or 2, characterised in that the tape is subjected to said at least one extraction step prior to the application of the tape around the core of the electric cable.

4. Method according to claim 3, characterised in that, with the tape being packaged in the form of a roll, said roll is placed in an extraction chamber for a sufficient duration to enable said extraction.

5. Method according to any one of claims 1 to 4, characterised in that the electric cable provided with the tape and packaged in a roll is placed in an extraction chamber for a sufficient duration to enable said extraction.

6. Method according to any one of claims 1 to 5, characterised in that the tape is subjected to at least one extraction step, during the application of the tape on the core of the electric cable.

7. Method according to any one of claims 1 to 6, characterised in that at least one extraction step is a step of heating the tape, to a temperature selected to enable said extraction.

8. Method according to claim 7, characterised in that said step of heating the tape is carried out by means of a radiative heating member or an inductive heating member.

9. Method according to any one of claims 7 or 8, characterised in that at least one extraction step comprises at least one step of blowing a flow of a gaseous composition in contact with the tape, said tape extending at the external surface of the electric cable being manufactured.

10. Method according to claim 9, characterised in that the blowing of a flow of a gaseous composition in contact with the tape is carried out in a tubular space open at its two longitudinal ends and in which the electric cable being manufactured and said tape extending on the surface of said electric cable being manufactured are moved together.

11. Method according to any one of claims 7 to 10, characterised in that with at least one chemical species of the tape being water, the heating temperature of the tape is selected to enable an extraction of at least some of this water.

12. Method according to any one of claims 7 to 11, characterised in that the heating temperature of the tape is between 50° C. and 100° C.

13. Method according to any one of claims 1 to 12, characterised in that the electric cable is a high-voltage electric cable in which each layer of the insulating system comprises—in particular consists of—at least one cross-linked polyethylene.

14. Method according to any one of claims 1 to 13, characterised in that with the electric cable being an underwater cable comprising connectors, tape portions extending facing the connectors are subjected to said at least one extraction step.

15. Method according to any one of claims 1 to 14, characterised in that the electric cable is a direct current electric cable (HVDC).

16. Method according to any one of claims 1 to 14, characterised in that the electric cable is an alternating current electric cable (HVAC).

17. Medium- or high-voltage electric cable able to be obtained—in particular obtained—by a method according to any one of claims 1 to 16.
